(19) United States
(12) Patent Application Publication
(10) Pub. No.: US 2018/0225162 A1
(43) Pub. Date: Aug. 9, 2018

(54) FLEXIBLE COMMAND LINE INTERFACE REDIRECTION

(71) Applicant: Brocade Communications Systems LLC, San Jose, CA (US)

(72) Inventors: Rajib Dutta, Cupertino, CA (US); Tony Devadason Titus, Milpitas, CA (US)

(73) Assignee: Brocade Communications Systems LLC, San Jose, CA (US)

(21) Appl. No.: 15/941,652

(22) Filed: Mar. 30, 2018

Related U.S. Application Data
(63) Continuation of application No. PCT/US2017/201703, filed on May 17, 2017.
(60) Provisional application No. 62/343,762, filed on May 31, 2016.

(51) Int. Cl. G06F 9/54

(52) U.S. Cl. CPC G06F 9/544; G06F 9/45558

(57) ABSTRACT

Systems, methods, apparatus, and computer-readable medium are described for executing a foreground bound process with characteristics similar to a background process. In certain implementations, a code wrapper is executed before and/or after the foreground bound process is invoked that dissociates the process input/output with the standard input/output provided by the operating system and redirects the input/output such that the foreground process no longer blocks the input/output and another process can interact with the foreground bound process.

### CROSS-REFERENCES TO RELATED APPLICATIONS

This application is a (bypass) continuation of International Application No. PCT/US2017/033145, filed May 17, 2017, entitled, “FLEXIBLE COMMAND LINE INTERFACE REDIRECTION,” which claims benefit and priority from U.S. Provisional Application No. 62/343,762, filed May 31, 2016, entitled, “FLEXIBLE COMMAND LINE INTERFACE REDIRECTION.” The entire content of PCT/US2017/033145 and 62/343,762 applications are incorporated herein by reference for all purposes.

### BACKGROUND

Many existing processes are foreground bound and assume ownership of the standard Input/Output (STDIO) interface. In many instances, such processes block on the STDIO and cannot be easily run as background processes. Foreground bound processes are routinely encountered while using software development kits (SDK's). Inability to run the SDK as a background process can be severely limiting in certain instances, where another foreground process and/or background process needs to use the SDK or run multiple foreground processes concurrently.

### SUMMARY

The present disclosure relates generally to operating system and application technologies, and more particularly to executing a foreground bound process with characteristics similar to a background process.

Example techniques for executing a foreground bound process with characteristics similar to a background process are provided. The technique may include redirecting the input and output for the executing environment using operating system features/commands such as pipes, FIFOs, files, file descriptors, dup (e.g., Unix or Unix based features and commands) that can be accessed by other foreground and/or background client programs. Example of a foreground bound process is a software development kit (SDK). The client program may provide input to the SDK through a first named pipe and receive output from the SDK through as second named pipe. In addition, a TEE (e.g., Unix or Unix based command) or thread similar to a TEE command may be used to also send the output to the SDK's standard output port. Wrapper code/script (i.e., instructions that execute prior to and/or after the process is initiated and/or executed) may be used for redirecting the input/output of the process, as disclosed above. In certain embodiments, a client program may be used for interacting with the process using the named pipes, such that the client process may connect to the first named pipe to provide input to the process and connect to the second named pipe to retrieve output from the process. The client may be executed in an interactive mode or non-interactive mode. In interactive mode, the client continues to interact with the program by providing input using the first named pipe and retrieving output using the second named pipe from the program. In non-interactive mode, the client may provide input using the first named pipe, retrieve output using the second named pipe and terminates itself

In an example method, apparatus, instructions stored on non-transitory computer readable medium or system, techniques are disclosed to close a standard input associated with the operating environment (STDIN). Furthermore, the techniques may assign a file descriptor for an input that was previously assigned to the standard input to a first named pipe. The technique may also close a standard output associated with the operating environment (STDOUT). The technique may assign a file descriptor for an output previously assigned to the standard output to a second named pipe or a TEE. In certain embodiments, the TEE forwards output to a second named pipe and a text input/output environment (TTY).

In certain embodiments, a device, such as a network device may execute the techniques disclosed above.

### BRIEF DESCRIPTION OF THE DRAWINGS

FIG. 1 is an example block diagram of a network device 100 (also referred to as a “host system”), according to certain embodiments.

FIG. 2 is an example block diagram of yet another example network device, according to certain embodiments.

FIG. 3 is an example block diagram of an example server executing an example SDK, according to certain embodiments.

FIG. 4 is an example block diagram of a server that illustrates closing and redirecting of input and output for an example SDK, according to certain embodiments.

FIG. 5 is an example block diagram of the server that illustrates sending the output to multiple destinations, according to certain aspects of the disclosure.

FIG. 6 is an example block diagram that illustrates an example server and example client, according to certain embodiments.

FIG. 7 is an example flow diagram illustrating a simplified method, according to certain aspects of the disclosure.

FIG. 8 is an example block diagram that discloses an example server and an example client, according to certain embodiments.

FIG. 9 is an example flow diagram illustrating a simplified method, according to certain aspects of the invention.

FIG. 10 is an example flow diagram illustrating a simplified method, according to certain aspects of the invention.

FIG. 11 is an example flow diagram illustrating a simplified method, according to certain aspects of the disclosure.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to operating system technologies and/or networking technologies, and, more particularly, to enabling running foreground bound processes as background processes.

Many existing processes are foreground bound and assume ownership of the standard Input/Output (STDIO) interface. In many instances, such processes block on the STDIO and cannot be easily run as background processes. Foreground bound processes are routinely encountered while using software development kits (SDK's). Inability to run the SDK as a background process can be severely limiting in certain instances, where another foreground process and/or background process needs to use the SDK or run multiple foreground processes concurrently.

Traditionally, to avoid monopolization of the current processes STDIO by the SDK, the SDK is run as a server and the current process is run as a client to the server. In such instances, the client accesses the SDK functionality through an application programming interface (API) provided by the SDK instead of using the SDK's CLI. This mode of executing the SDK and accessing its functionality may need significant amounts of software development. Furthermore, several SDK's do not provide API's and are not accessible through such a work around.

Systems, methods, apparatus and computer-readable medium are described for executing a foreground bound with characteristics similar to a background process, such that the foreground bound process no longer blocks the Standard Input/Output. This allows several foreground bound processes to be executed concurrently while providing the client the ability to interact with each of the executed foreground bound processes. In certain implementations, a code wrapper is executed before the foreground bound process is invoked that dissociates the foreground bound processes I/O with the STDIO provided by the operating system for the processes I/O and redirects the processes I/O.

Although SDKs are discussed in detail here, aspects of the disclosure may be applied without limitation to any process, application and/or thread without limiting the scope of the invention.

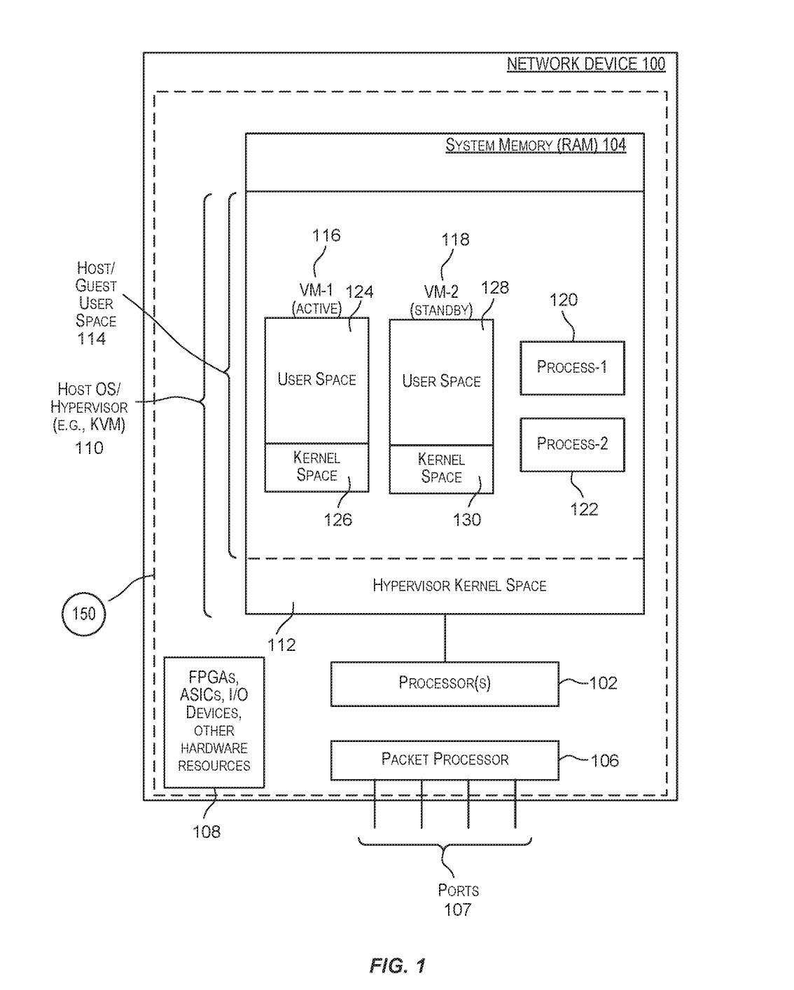

FIG. 1 is a simplified block diagram of a network device 100 (also referred to as a “host system”) that may incorporate teachings disclosed herein according to certain embodiments. Network device 100 may be any device that is capable of receiving and forwarding packets, which may be data packets or signaling or protocol-related packets (e.g., keep-alive packets). For example, network device 100 may receive one or more data packets and forward the data packets to facilitate delivery of the data packets to their intended destinations. In certain embodiments, network device 100 may be a router or switch such as various routers and switches provided by Brocade Communications Systems, Inc. of San Jose, Calif.

As depicted in FIG. 1, the example network device 100 comprises multiple components including one or more processors 102, a system memory 104, a packet processor 106 (which may also be referred to as a traffic manager), and optionally other hardware resources or devices 108. Network device 100 depicted in FIG. 1 is merely an example and is not intended to unduly limit the scope of inventive embodiments recited in the claims. One of ordinary skill in the art would recognize many possible variations, alternatives, and modifications. For example, in some implementations, network device 100 may have more or fewer components than those shown in FIG. 1, may combine two or more components, or may have a different configuration or arrangement of components. Network device 100 depicted in FIG. 1 may also include (not shown) one or more communication channels (e.g., an interconnect or a bus) for enabling multiple components of network device 100 to communicate with each other.

Network device 100 may include one or more processors 102. Processors 102 may include single or multicore processors. System memory 104 may provide memory resources for processors 102. System memory 104 is typically a form of random access memory (RAM) (e.g., dynamic random access memory (DRAM), Synchronous DRAM (SDRAM), Double Data Rate SDRAM (DDR SDRAM)). Information related to an operating system and programs or processes executed by processors 102 may be stored in system memory 104. Processors 102 may include general purpose microprocessors such as ones provided by Intel®, AMD®, ARM®, Freescale Semiconductor, Inc., and the like, that operate under the control of software stored in associated memory.

As shown in the example depicted in FIG. 1, a host operating system 110 may be loaded in system memory 104 and executed by one or more processors 102. Host operating system 110 may be loaded, for example, when network device 104 is powered on. In certain implementations, host operating system 110 may also function as a hypervisor and facilitate management of virtual machines and other programs that are executed by network device 100. Managing virtual machines may include partitioning resources of network device 100, including processor and memory resources, between the various programs. A hypervisor is a program that enables the creation and management of virtual machine environments including the partitioning and management of processor, memory, and other hardware resources of network device 100 between the virtual machine environments. A hypervisor enables multiple guest operating systems (GOSs) to run concurrently on network device 100.

As an example, in certain embodiments, host operating system 110 may include a version of a KVM (Kernel-based Virtual Machine), which is an open source virtualization infrastructure that supports various operating systems including Linux, Windows®, and others. Other examples of hypervisors include solutions provided by VMWare®, Xen®, and others. Linux KVM is a virtual memory system, meaning that addresses seen by programs loaded and executed in system memory are virtual memory addresses that have to be mapped or translated to physical memory addresses of the physical memory. This layer of indirection enables a program running on network device 100 to have an allocated virtual memory space that is larger than the system's physical memory.

In the example depicted in FIG. 1, the memory space allocated to operating system 110 (operating as a hypervisor) is divided into a (hypervisor) kernel space 112 and a user space 114 (also referred to as host user space or guest user space). Multiple virtual machines and host processes may be loaded into guest user space 114 and executed by processors 102. The memory allocated to a virtual machine (also sometimes referred to as a guest operating system or GOS) may in turn include a kernel space portion and a user space portion. A virtual machine may have its own operating system loaded into the kernel space of the virtual machine. A virtual machine may operate independently of other virtual machines executed by network device 100 and may be unaware of the presence of the other virtual machines.

A virtual machine's operating system may be the same as, or different from, the host operating system 110. When multiple virtual machines are being executed, the operating system for one virtual machine may be the same as, or different from, the operating system for another virtual machine. In this manner, operating system 110, for example, through a hypervisor enables multiple guest operating systems to share the hardware resources (e.g., processor and memory resources) of network device 100.

For example, in the embodiment depicted in FIG. 1, two virtual machines VM-1 116 and VM-2 118 have been loaded into user space 114 and are being executed by processors 102. VM-1 116 has a guest kernel space 126 and a guest user space 124. VM-2 118 has its own guest kernel space 130 and guest user space 128. Typically, each virtual machine has its own secure and private memory area that is accessible only to that virtual machine. In certain implementations, the creation and management of virtual machines 116 and 118 may be managed by hypervisor running on top of or in conjunction with the operating system 110. The virtualization infrastructure can be provided, for example, by KVM. While only two virtual machines are shown in FIG. 1, this is not intended to be limiting. In alternative embodiments, any number of virtual machines may be loaded and executed.

Various other host programs or processes may also be loaded into user space 114 and be executed by processors 102. For example, as shown in the embodiment depicted in FIG. 1, two host processes 120 and 122 have been loaded into user space 114 and are being executed by processors 102. While only two host processes are shown in FIG. 1, this is not intended to be limiting. In alternative embodiments, any number of host processes may be loaded and executed.

In certain embodiments, a virtual machine may run a network operating system (NOS) (also sometimes referred to as a network protocol stack) and be configured to perform processing related to forwarding of packets from network device 100. As part of this processing, the virtual machine may be configured to maintain and manage routing information that is used to determine how a data packet received by network device 100 is forwarded from network device 100. In certain implementations, the routing information may be stored in a routing database (not shown) stored by network device 100. The virtual machine may then use the routing information to program a packet processor 106, which then performs packet forwarding using the programmed information, as described below.

The virtual machine running the NOS may also be configured to perform processing related to managing sessions for various networking protocols being executed by network device 100. These sessions may then be used to send signaling packets (e.g., keep-alive packets) from network device 100. Sending keep-alive packets enables session availability information to be exchanged between two ends of a forwarding or routing protocol.

In certain implementations, redundant virtual machines running network operating systems may be provided to ensure high availability of the network device. In such implementations, one of the virtual machines may be configured to operate in an “active” mode (this virtual machine is referred to as the active virtual machine) and perform a set of functions while the other virtual machine is configured to operate in a “standby” mode (this virtual machine is referred to as the standby virtual machine) in which the set of functions performed by the active virtual machine are not performed. The standby virtual machine remains ready to take over the functions performed by the active virtual machine. Conceptually, the virtual machine operating in active mode is configured to perform a set of functions that are not performed by the virtual machine operating in standby mode. For example, the virtual machine operating in active mode may be configured to perform certain functions related to routing and forwarding of packets from network device 100, which are not performed by the virtual machine operating in standby mode. The active virtual machine also takes ownership of, and manages the hardware resources of, the network device 100.

Certain events may cause the active virtual machine to stop operating in active mode and for the standby virtual machine to start operating in the active mode (i.e., become the active virtual machine) and take over performance of the set of functions related to network device 100 that are performed in active mode. The process of a standby virtual machine becoming the active virtual machine is referred to as a failover or switchover. As a result of the failover, the virtual machine that was previously operating in active mode prior to the failover may operate in the standby mode after the failover. A failover enables the set of functions performed in active mode to be continued to be performed without interruption. Redundant virtual machines used in this manner may reduce or even eliminates the downtime of network device 100's functionality, which may translate to higher availability of network device 100. The set of functions that is performed in active mode, and which is not performed by the active virtual machine and not performed by the standby virtual machine may differ from one network device to another.

Various different events may cause a failover to occur. Failovers may be voluntary or involuntary. A voluntary failover may be purposely caused by an administrator of the network device or network. For example, a network administrator may, for example, using a command line instruction, purposely cause a failover to occur. There are various situations when this may be performed. As one example, a voluntary failover may be performed when software for the active virtual machine is to be brought offline so that it can be upgraded. As another example, a network administrator may cause a failover to occur upon noticing performance degradation on the active virtual machine or upon noticing that software executed by the active computing domain is malfunctioning.

An involuntary failover typically occurs due to some critical failure in the active virtual machine. This may occur, for example, when some condition causes the active virtual machine to be rebooted or reset. This may happen, for example, due to a problem in the virtual machine kernel, critical failure of software executed by the active virtual machine, and the like. An involuntary failover causes the standby virtual machine to automatically become the active virtual machine.

In the example depicted in FIG. 1, VM-1 116 is shown as operating in active mode and VM-2 118 is shown as operating in standby mode. The active-standby model enhances the availability of network device 100 by enabling the network device to support various high-availability functionality such as graceful restart, non-stop routing (NSR), and the like.

During normal operation of network device 100, there may be some messaging that takes place between the active virtual machine and the standby virtual machine. For example, the active virtual machine may use messaging to pass network state information to the standby virtual machine. The network state information may comprise information that enables the standby virtual machine to become the active virtual machine upon a failover or switchover in a non-disruptive manner. Various different schemes may be used for the messaging, including, but not restricted to, Ethernet-based messaging, Peripheral Component Interconnect (PCI)-based messaging, shared memory based messaging, and the like.

Hardware resources or devices 108 may include without restriction one or more field programmable gate arrays (FPGAs), application specific integrated circuits (ASICs), I/O devices, and the like. I/O devices may include devices such as Ethernet devices, PCI Express (PCIe) devices, and others. In certain implementations, some of hardware resources 108 may be partitioned between multiple virtual machines executed by network device 100 or, in some instances, may be shared by the virtual machines. One or more of hardware resources 108 may assist the active virtual machine in performing networking functions. For example, in certain implementations, one or more FPGAs may assist the active virtual machine in performing the set of functions performed in active mode.

As previously indicated, network device 100 may be configured to receive and forward packets to facilitate delivery of the packets to their intended destinations. The packets may include data packets and signal or protocol packets (e.g., keep-alive packets). The packets may be received and/or forwarded using one or more ports 107. Ports 107 represent the I/O plane for network device 100. A port within ports 107 may be classified as an input port or an output port depending upon whether network device 100 receives or transmits a packet using that port. A port over which a packet is received by network device 100 may be referred to as an input port. A port used for communicating or forwarding a packet from network device 100 may be referred to as an output port. A particular port may function both as an input port and an output port. A port may be connected by a link or interface to a neighboring network device or network. In some implementations, multiple ports of network device 100 may be logically grouped into one or more trunks.

Ports 107 may be capable of receiving and/or transmitting different types of network traffic at different speeds, such as speeds of 1 Gigabits per second (Gbps), 10 Gbps, 100 Gbps, or more. Various different configurations of ports 107 may be provided in different implementations of network device 100. For example, configurations may include 72 10 Gbps ports, 60 40 Gbps ports, 36 100 Gbps ports, 24 25 Gbps ports+10 48 Gbps ports, 12 40 Gbps ports+10 48 Gbps ports, 12 50 Gbps ports+10 48 Gbps ports, 6 100 Gbps ports+10 48 Gbps ports, and various other combinations.

In certain implementations, upon receiving a data packet via an input port, network device 100 is configured to determine an output port to be used for transmitting the data packet from network device 100 to facilitate communication of the packet to its intended destination. Within network device 100, the packet is forwarded from the input port to the determined output port and then transmitted or forwarded from network device 100 using the output port.

Various different components of network device 100 are configured to cooperatively perform processing for determining how a packet is to be forwarded from network device 100. In certain embodiments, packet processor 106 may be configured to perform processing to determine how a packet is to be forwarded from network device 100. In certain embodiments, packet processor 106 may be configured to perform packet classification, modification, forwarding and Quality of Service (QoS) functions. As previously indicated, packet processor 106 may be programmed to perform forwarding of data packets based upon routing information maintained by the active virtual machine. In certain embodiments, upon receiving a packet, packet processor 106 is configured to determine, based upon information extracted from the received packet (e.g., information extracted from a header of the received packet), an output port of network device 100 to be used for forwarding the packet from network device 100 such that delivery of the packet to its intended destination is facilitated. Packet processor 106 may then cause the packet to be forwarded within network device 100 from the input port to the determined output port. The packet may then be forwarded from network device 100 to the packet's next hop using the output port.

In certain instances, packet processor 106 may be unable to determine how to forward a received packet. Packet processor 106 may then forward the packet to the active virtual machine, which may then determine how the packet is to be forwarded. The active virtual machine may then program packet processor 106 for forwarding that packet. The packet may then be forwarded by packet processor 106.

In certain implementations, packet processing chips or merchant ASICs provided by various 3rd-party vendors may be used for packet processor 106 depicted in FIG. 1. For example, in some embodiments, Ethernet switching chips provided by Broadcom® or other vendors may be used. For example, in some embodiments, Qumran ASICs may, for example, be used in a pizza-box implementation, or Jericho packet processor chips (BCM88670) may, for example, be used in a chassis-based system, or other ASICs provided by Broadcom® may be used as packet processor 106. In alternative implementations, chips from other vendors may be used as packet processor 106.

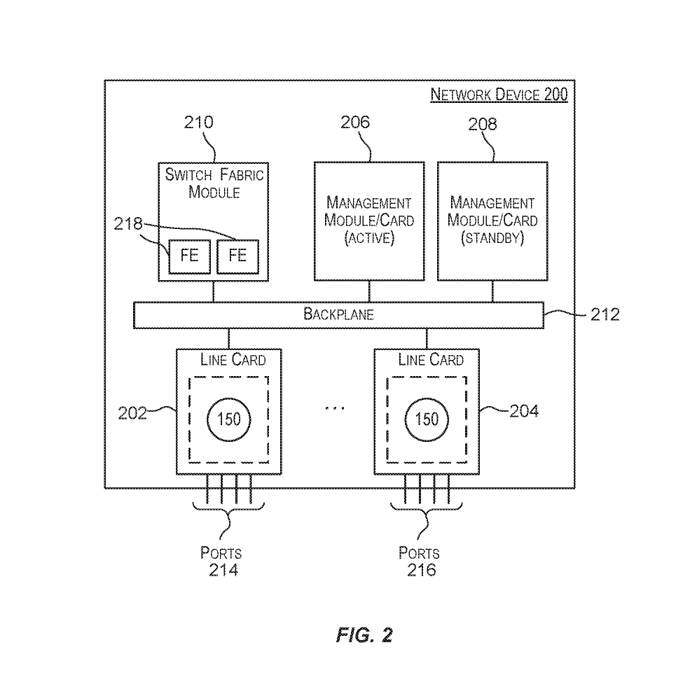

FIG. 2 is a simplified block diagram of yet another example network device 200. Network device 200 depicted in FIG. 2 is commonly referred to as a chassis-based system (network device 100 depicted in FIG. 1 is sometimes referred to as a “pizza-box” system). Network device 200 may be configured to receive and forward packets, which may be data packets or signaling or protocol-related packets (e.g., keep-alive packets). Network device 200 comprises a chassis that includes multiple slots, where a card or blade or module can be inserted into each slot. This modular design allows for flexible configurations, with different combinations of cards in the various slots of the network device for supporting differing network topologies, switching needs, and performance requirements.

In the example depicted in FIG. 2, network device 200 comprises multiple line cards (including first line card 202 and a second line card 204), two management cards/modules 206, 208, and one or more switch fabric modules (SFMs) 210. A backplane 212 is provided that enables the various cards/modules to communicate with each other. In certain embodiments, the cards may be hot swappable, meaning they can be inserted and/or removed while network device 200 is powered on. In certain implementations, network device 200 may be a router or a switch such as various routers and switches provided by Brocade Communications Systems, Inc. of San Jose, Calif.

Network device 200 depicted in FIG. 2 is merely an example and is not intended to unduly limit the scope of inventive embodiments recited in the claims. One of ordinary skill in the art would recognize many variations, alternatives, and modifications. For example, in some embodiments, network device 200 may have more or fewer components than shown in FIG. 2, may combine two or more components, or may have a different configuration or arrangement of components.

In the example depicted in FIG. 2, network device 200 comprises two redundant management modules 206, 208. The redundancy enables the management modules to operate according to the active-standby model, where one of the management modules is configured to operate in standby mode (referred to as the standby management module) while the other operates in active mode (referred to as the active management module). The active management module may be configured to perform management and control functions for network device 200 and may represent the management plane for network device 200. The active management module may be configured to execute applications for performing management functions such as maintaining routing tables, programming the line cards (e.g., downloading information to a line card that enables the line card to perform data forwarding functions), and the like. In certain embodiments, both the management modules and the line cards act as a control plane that programs and makes programming decisions for packet processors in a network device. In a chassis-based system, a management module may be configured as a coordinator of multiple control planes on the line cards.

When a failover or switchover occurs, the standby management module may become the active management module and take over performance of the set of functions performed by a management module in active mode. The management module that was previously operating in active mode may then become the standby management module. The active-standby model in the management plane enhances the availability of network device 200, allowing the network device to support various high-availability functionality such as graceful restart, non-stop routing (NSR), and the like.

In the example depicted in FIG. 2, management module 206 is shown as operating in active mode and management module 208 is shown as operating in standby mode. Management modules 206 and 208 are communicatively coupled to the line cards and switch fabric modules (SFMs) 210 via backplane 212. Each management module may comprise one or more processors, which could be single or multicore processors and associated system memory. The processors may be general purpose microprocessors such as ones provided by Intel®, AMD®, ARM®, Freescale Semiconductor, Inc., and the like, which operate under the control of software stored in associated memory.

A switch fabric module (SFM) 210 may be configured to facilitate communications between the management modules 206, 208 and the line cards of network device 200. There can be one or more SFMs in network device 200. Each SFM 210 may include one or more fabric elements (FEs) 218. The fabric elements provide an SFM the ability to forward data from an input to the SFM to an output of the SFM. An SFM may facilitate and enable communications between any two modules/cards connected to backplane 212. For example, if data is to be communicated from one line card 202 to another line card 206 of network device 200, the data may be sent from the first line card to SFM 210, which then causes the data to be communicated to the second line card using backplane 212. Likewise, communications between management modules 206, 208 and the line cards of network device 200 are facilitated using SFMs 210.

In the example depicted in FIG. 2, network device 200 comprises multiple line cards including line cards 202 and 204. Each line card may comprise a set of ports (214 and 216) that may be used for receiving and forwarding packets. The ports of a line card may be capable of receiving and/or transmitting different types of network traffic at different speeds, such as speeds of 1 Gbps, 10 Gbps, 100 Gbps, or more. Various different configurations of line card ports may be provided in network device 200. For example, configurations may include 72 10 Gbps ports, 60 40 Gbps ports, 36 100 Gbps ports, 24 25 Gbps ports+10 48 Gbps ports, 12 40 Gbps ports+10 48 Gbps ports, 12 50 Gbps ports+10 48 Gbps ports, 6 100 Gbps ports+10 48 Gbps ports, and various other combinations.

Each line card may include one or more single or multicore processors, a system memory, a packet processor, and one or more hardware resources. In certain implementations, the components on a line card may be configured similar to the components of network device 100 depicted in FIG. 1 (components collectively represented by reference 150 from FIG. 1 and also shown in line cards 202, 204 in FIG. 2).

A packet may be received by network device 200 via a port on a particular line card. The port receiving the packet may be referred to as the input port and the line card as the source/input line card. The packet processor on the input line card may then determine, based upon information extracted from the received packet, an output port to be used for forwarding the received packet from network device 200. The output port may be on the same input line card or on a different line card. If the output port is on the same line card, the packet is forwarded by the packet processor on the input line card from the input port to the output port and then forwarded from network device 200 using the output port. If the output port is on a different line card, then the packet is forwarded from the input line card to the line card containing the output port using backplane 212. The packet is then forwarded from network device 200 by the packet processor on the output line card using the output port.

In certain instances, the packet processor on the input line card may be unable to determine how to forward a received packet. The packet processor may then forward the packet to the active virtual machine on the line card, which then determines how the packet is to be forwarded. The active virtual machine may then program the packet processor on the line card for forwarding that packet. The packet may then be forwarded to the output port (which may be on the input line card or some other line card) by that packet processor and then forwarded from network device 200 via the output port.

In various implementations, a network device implemented as described in FIG. 1 and/or FIG. 2 may be a chassis-based system. In these implementations, the management modules, line cards, and switch fabric modules can each be “hot-plugged” or “hot-swapped,” meaning that these components can be inserted into or removed from the network device while the network device is in operation. The term “hot-plug” can refer to both the physical insertion or removal of a component into a chassis, as well as connecting the devices on the component to a virtual machine (e.g., “virtual” hot-plug in the virtual environment of the virtual machine). In the latter case, the component may be present and powered on in the chassis before the virtual machine is booted, and may be, as discussed further below, undiscoverable to the virtual machine until the virtual machine is on line and able to take steps to make the component visible.

In certain instances, the active virtual machine on an input line card may be unable to determine how to forward a received packet. The packet may then be forwarded to the active management module, which then determines how the packet is to be forwarded. The active management module may then communicate the forwarding information to the line cards, which may then program their respective packet processors based upon the information. The packet may then be forwarded to the line card containing the output port (which may be on an input line card or some other line card) and then forwarded from network device 200 via the output port.

In certain embodiments, techniques are provided for executing a foreground bound process with certain characteristics of a background process, such that the foreground process no longer blocks the standard Input/Output (STDIO). In certain implementations, the foreground bound process is executed in the code wrapper (i.e., instructions executed prior to and/or after the foreground bound process) that dissociates the foreground bound processes I/O from the STDIO provided by the operating system and redirects the processes I/O.

In certain implementations, named pipes (e.g., X, Y) and/or TEE's are created in the wrapper process with the same file descriptor numbers as standard input (STDIN) and standard output (STDOUT) so that no changes to the SDK itself are needed. A pipe is a mechanism provided by the operating system for passing information from one program process to another. This allows the SDK to run in the background blocking on the named pipes (e.g., X, Y) instead of the STDIO. Since the named pipes are known (or advertised) to the user or a client process, the client process can connect to the named pipes directly.

In certain embodiments, the wrapper process closes STDIN and opens a read pipe X, such that the named piped X assumes the file descriptor ID 0 (for Input). Such redirection allows implicit reads for the SDK to receive input from X. In other words, any reads from the SDK blocks on the input from X.

In certain instances, the wrapper process duplicates the STDOUT to pipe TTY, such that TTY connects to the STD output device. In certain instances, this may normally be the TTY/PTY device where the SDK wrapper process may be running. In certain implementations, a TEE thread may be created which reads from the output of the process and sends it out to both the output pipe as well as the STDOUT (TTY console port).

Furthermore, in certain other implementations, the wrapper process closes out the STDOUT and opens a pipe TEE. TEE's are operating system (e.g., UNIX or UNIX based) commands used in the middle of a pipe to allow redirection of output to a file (e.g., TTY) and also forward the output to a named pipe (i.e., Y).

In certain implementations, the STDOUT may be closed and a new TEE may be opened. This allows all the routines from the SDK that implicitly assume STDOUT as output device to be sent to the TEE. The TEE may be connected to a named pipe Y that assumes the file descriptor 1 (i.e., output). As described above, the TEE can also be connected to the TTY/PTY device of the SDK so that the TTY/PTY also receives the output from the SDK.

In certain implementations, the STDERR may also be closed and TEE'd (or piped) to another named pipe (e.g., Z) allowing logging of error conditions.

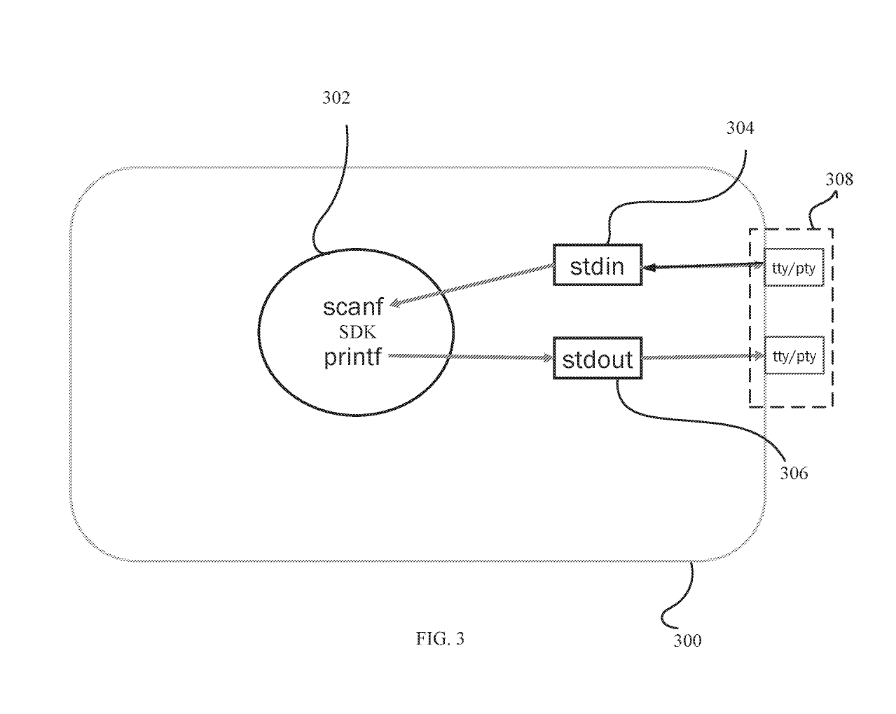

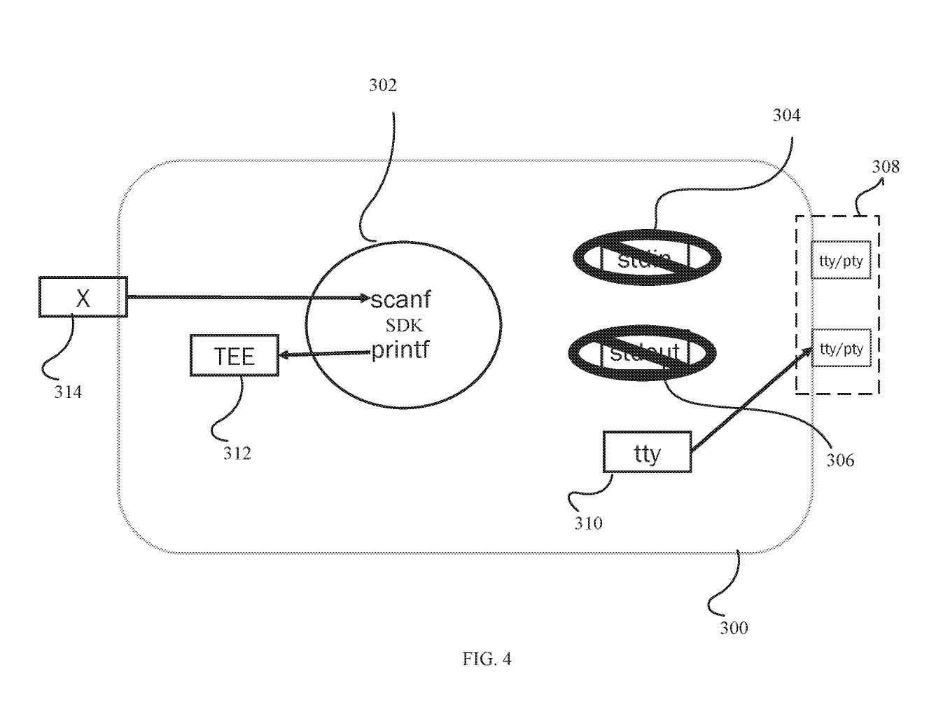

FIG. 3 is a block diagram of an example server 300 executing an SDK 302 illustrating a few simple functions with input and output functionality. The SDK 302 executes a simple input function, such as scanf ( ). As shown in FIG. 3, scanf ( ) reads formatted input from standard input stream STDIN 304 which is tied to the current processes TTY/PTY 308. The block diagram also illustrates the SDK 302 executing an output function, such as printf ( ) Printf ( ) outputs formatted data to the standard output stream STDOUT 306, which is tied to the current process's TTY/PTY 308. Although FIG. 3 and the subsequent FIGS. 4, 5 and 6 disclose an SDK, any foreground bound process may be used without deviating from the scope of the disclosure.

FIG. 4 is a block diagram of the server 300 that illustrates closing of the STDIN 304 and STDOUT 306 and redirecting the input and output for the SDK 302 from the TTY/PTY 308, according to certain embodiments. For example, the input for the SDK thread is redirected to a named pipe X 314. Furthermore, in certain instances, the output of the printf ( ) may be TEE'd (block 310), such that the output of the printf can be sent to multiple destinations while still forwarding the output to the TTY/PTY 308 via the TTY 310.

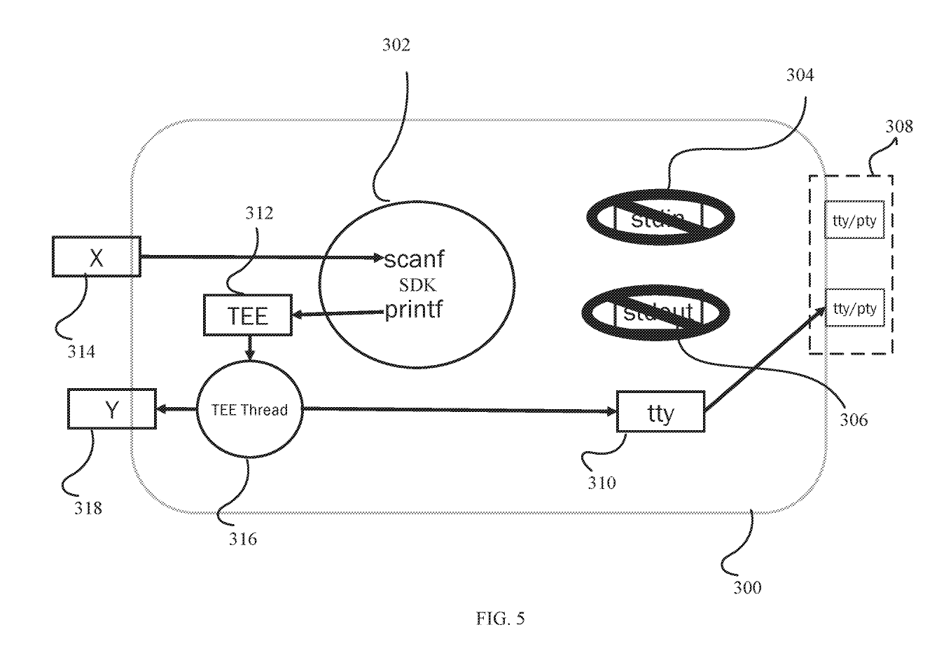

FIG. 5 is a block diagram of the server 300 that illustrates sending the output to multiple destinations, according to certain aspects of the disclosure. In FIG. 5, the output from printf is redirected to the TEE 312. In certain embodiments, TEE may be yet another named pipe or buffer. The TEE thread 316 forwards the data from the TEE 312 to the named pipe Y 318 and the TTY/PTY 310/308 of the SDK simultaneously, therefore avoiding disruption of the normal expected behavior by the SDK.

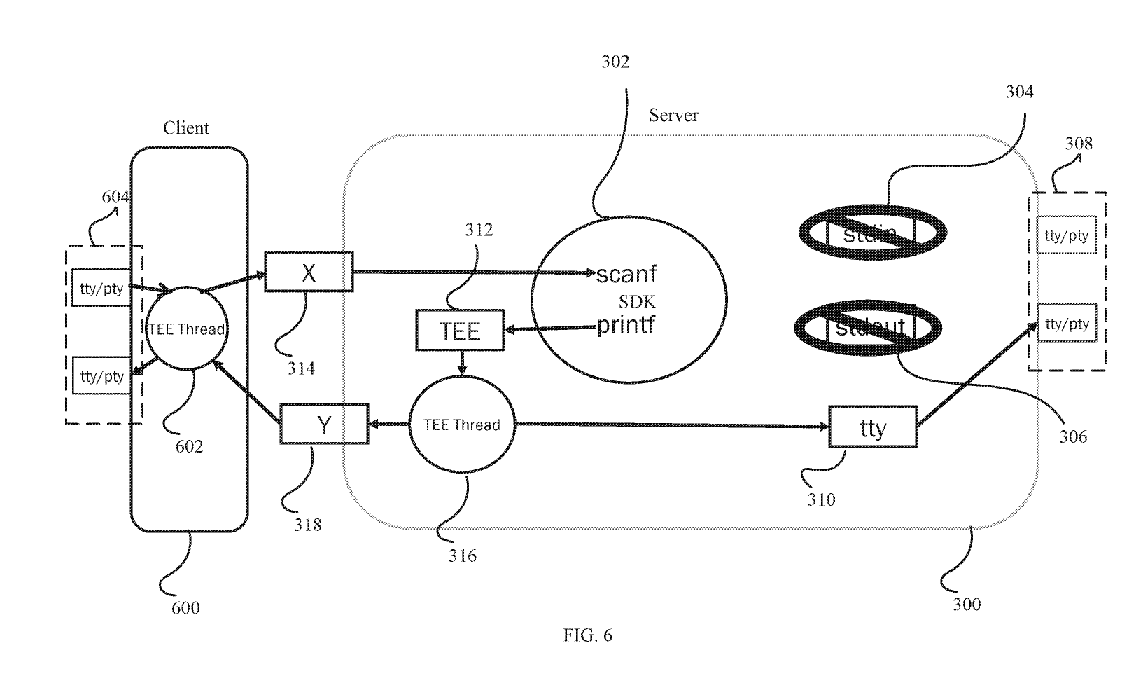

FIG. 6 is a block diagram that illustrates an example server 300 and client 600. As disclosed in FIG. 6 and previous figures, the input/output of the server is redirected to named pipes (or buffers) X 314 and Y 316 and the local console 308. FIG. 6 also discloses a client 600 executing as an example foreground process that attaches itself to the known named pipes (X 314 and Y 316) for interacting with the SDK 302 using the SDK's command line interface (CLI). The input for the foreground process executing as the client 600 is TEE'd (block 602) to the named input pipe X 314. Similarly, the named output pipe Y 318 for the SDK is TEE'd to the TTY/PTY 604 of the foreground process.

Therefore, as described above, the foreground process can interact with the SDK running as a non I/O blocking process similar to a background using the SDK's native CLI. In certain implementations, very little to no development, changes to the SDK or processing overhead are needed for interacting with the SDK using the SDK's CLIs.

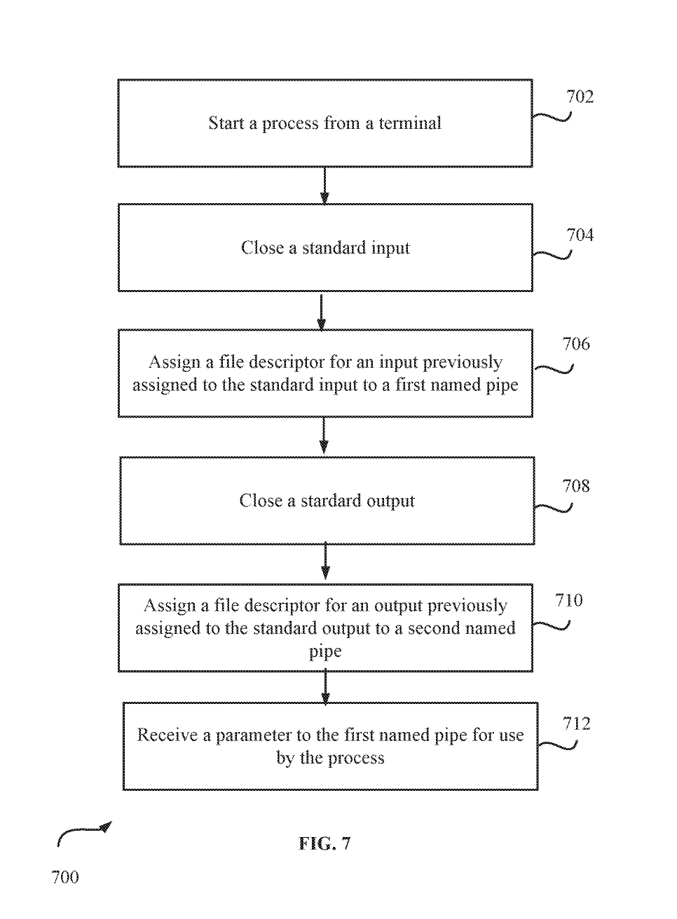

FIG. 7 is a flow diagram 700 illustrating a simplified method, according to certain aspects of the invention. The method disclosed in FIG. 7 may be performed using instructions stored in memory, such as a non-transient computer readable medium using one or more processors. In certain embodiments, the method may be performed using one or more components disclosed with reference to FIG. 1 and FIG. 2. In certain embodiments, the method may be performed in a network device.

At block 702, the server process may be initiated on a device. The server process may include a foreground bound process, such as an SDK. In certain other instances, the server process may be initiated after a client process is initiated. In certain instances, the blocks 704-710 of the code wrapper may be performed prior to execution of block 702. In other words, in certain embodiments, the redirection of the process input/output may be performed prior to executing the process. Code wrapper refers to instructions executed prior to and/or after the target process (foreground bound process) is executed. As disclosed in more detail below, the code wrapper redirects the standard input/output for the target process.

At block 704, the code wrapper may close a standard input associated with the operating environment (STDIN). Furthermore, at block 706, the code wrapper may assign a file descriptor for an input that was previously assigned to the standard input to a first named pipe. In certain embodiments, closing of the STDIN relinquishes file descriptor “0” for the terminal process. Opening of the first named pipe assigns the lowest available file descriptor to the first named pipe. Therefore, closing the STDIN and opening the first named pipe immediately automatically assigns the “0” (that is the file descriptor for STDIN) to the first named pipe. In certain implementations, a named pipe may be implemented as a buffer, such as a first in first out (FIFO) file.

At block 708, the code wrapper may close a standard output associated with the operating environment (STDOUT). Furthermore, at block 710, the code wrapper may assign a file descriptor for an output previously assigned to the standard output to a TEE. In certain embodiments, the TEE forwards output to a second named pipe and a text input/output environment (TTY). In certain embodiments, closing of the STDOUT relinquishes file descriptor “1” for the terminal process. Opening of the second named pipe assigns the lowest available file descriptor to the second named pipe at the time. Therefore, closing the STDOUT and opening the second named pipe immediately automatically assigns the “1” (that is the file descriptor for STDOUT) to the second named pipe. In certain implementations, a named pipe may be implemented as a buffer, such as a first in first out (FIFO) file. In certain embodiments, TEE may also be implemented as a named pipe in combination with a thread that monitors the buffer associated with the named pipe and forwards the output of the buffer to the console and the second named pipe.

At block 712, the process may receive input from the client via the first named pipe. The client may provide input to the method in interactive mode or non-interactive mode. In interactive mode, the client continues to provide input and receive output from the process via the named pipes. In non-interactive mode, the client may provide input, receive output and relinquish the terminal for access by another program/process.

In certain implementations, the above method may be performed by a (shell/code) wrapper for accessing functionality provided by an SDK through its command line interface from a foreground client. A foreground process may connect to the first and second named pipes and interact with the SDK. The client may perform in interactive mode or non-interactive mode. In interactive mode, the client continues to provide input and receive output from the SDK via the named pipes. In non-interactive mode, the client may provide input, receive output and relinquish the terminal for access by another program/process.

As STDIO is redirected, as discussed above, special considerations are made to avoid the loss of logs before the client can attach to the SDK. Similarly, if the output for the SDK needs to go to the console device without blocking on new named pipes ReadFD X/WriteFD Y, another level of redirection may be needed that unblocks the SDK. In some instances, creating a TEE pipe/buffer/FIFO and a thread and outputting the STDIO to the TTY/PTY of the console may alleviate the risk of losing output.

Steps and techniques described with respect to FIG. 7, in certain embodiments, may be implemented sequentially and/or concurrently with or without additional steps between them. Furthermore, certain steps may be performed out of order without deviating from the scope of the invention.

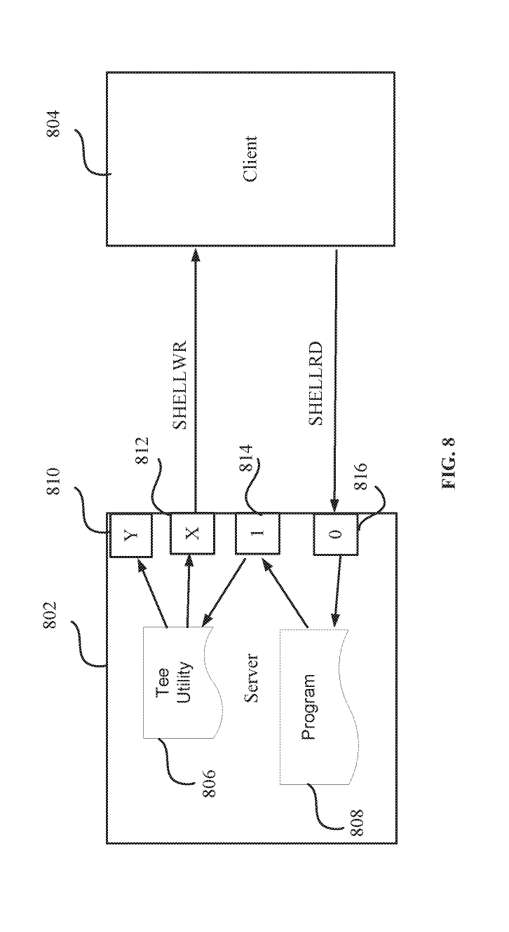

FIG. 8 is an example block diagram that discloses a server 802 and a client 804. The server 802 may include a program 808, such as a foreground bound process that traditionally blocks the standard input/output. An example of such a foreground process is a Software Development Kit (SDK). Inability to run the foreground process that requires interaction as a background process can be severely limiting in certain instances, where another foreground process and/or background process needs to execute concurrently. The client 804 may be another foreground process that is initiated either on the same device as the server 802 or on a remote device to interact with the program 808.

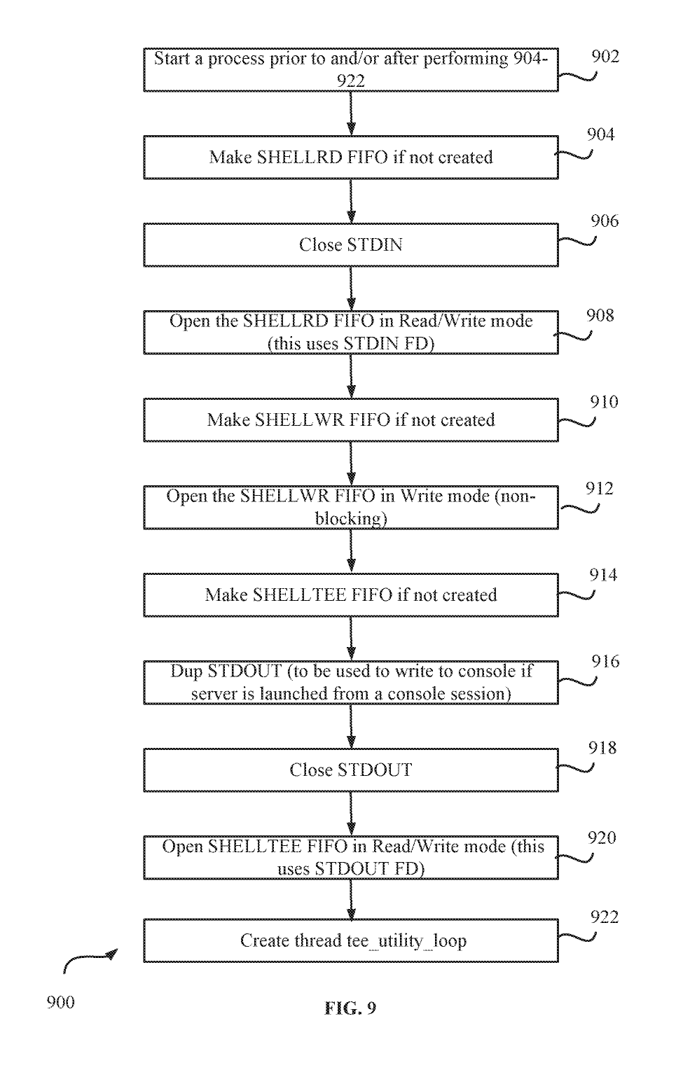

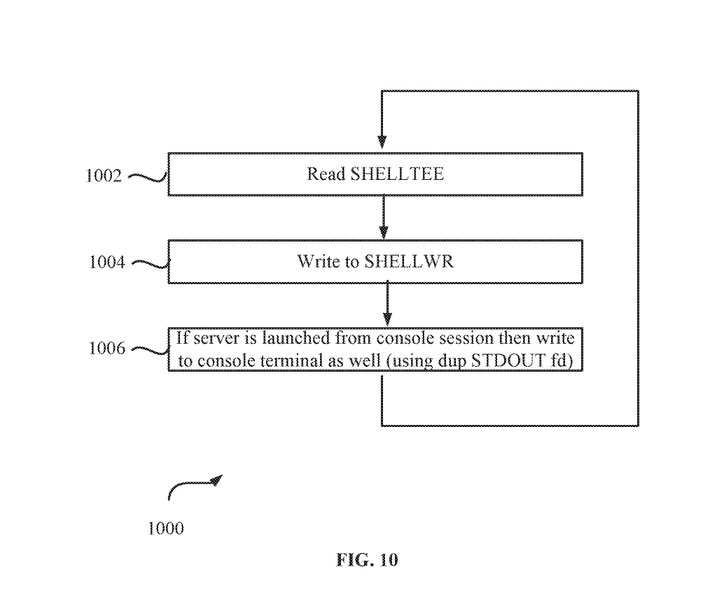

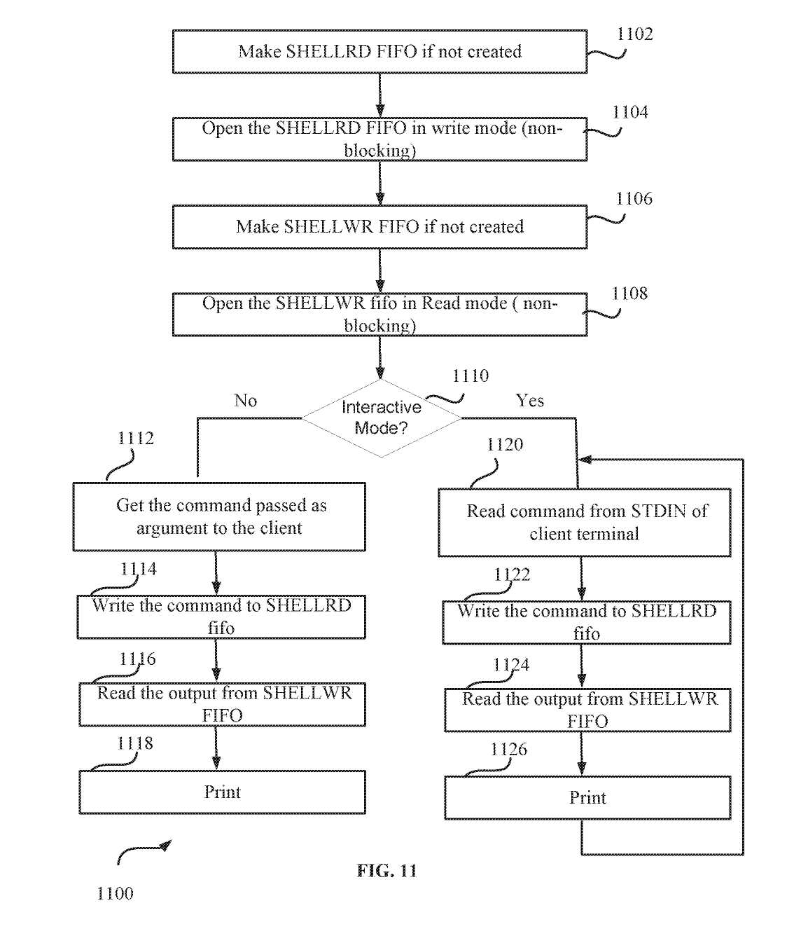

As illustrated in FIG. 8, the server 802 may also include a code wrapper that includes instructions that are executed prior to and/or after the program 808 is executed for redirecting the input and output of the program 808. The program 808 receives the input from a buffer associated with the file descriptor “0.” Techniques are described for providing input to the program 808 from the client 804 to the program 808 via the buffer 816. The program 808 provides the output to another buffer associated with the file descriptor “1” (block 814). Additional techniques are provided for redirecting the output from the program 808 using a tee utility 806 to buffers 810 and 812. FIG. 9 describes example techniques associated with the code wrapper executing as part of the server 802 in greater detail, FIG. 10 describes example techniques associated with the tee utility 806 in greater detail, and FIG. 11 describes example techniques associated with the client 804 in greater detail.

FIG. 9 is an example flow diagram 900 illustrating a simplified method, according to certain aspects of the invention. In certain embodiments, the method disclosed in FIG. 9 is a code wrapper executing as part of the server 802 of FIG. 8. The method disclosed in FIG. 9 may be performed using instructions stored in memory, such as a non-transient computer readable medium or system memory, using one or more processors. In certain embodiments, the method may be performed using one or more components disclosed with reference to FIG. 1 and FIG. 2. In certain embodiments, the method may be performed in a network device.

At block 902, the program 808 of server 802 may be initiated on a device. The program 808 may include a foreground bound process, such as an SDK. In certain other instances, the program 808 may be initiated after a client 804 is initiated. In certain instances, blocks 904-922 of the code wrapper may be performed prior to execution of block 902. In other words, in certain embodiments, the redirection of the process input/output may be performed prior to executing the program 808. Code wrapper refers to instructions executed prior to and/or after the program 808 is executed. As disclosed in more detail below, the code wrapper redirects the standard input/output for the program. An example of the program is an SDK.

At block 904, the method creates a buffer. In certain embodiments, the method initiates a named pipe by making the buffer as a first in first out (FIFO) file. In one embodiment, the named pipe is SHELLRD FIFO. In certain embodiments, the client may be initiated prior to the execution of this method and the SHELLRD FIFO may exist. In such instances, the making of the SHELLRD FIFO at block 904 may be skipped.

At block 906, the method closes the standard input (STDIN). Closing of the STDIN relinquishes the file descriptor for the standard input. In certain instances, the file descriptor for STDIN is “0.”

At block 908, the method opens the SHELLRD FIFO in Read/Write mode. Opening of the SHELLRD FIFO assigns the SHELLRD FIFO the lowest available file descriptor. Therefore, it is important to open the SHELLRD FIFO as soon as the STDIN is closed, so that the file descriptor for the STDIN is assigned to the SHELLRD FIFO. The SHELLRD FIFO is used for the program 808 to read input from the client. The program 808 reads from the file associated with file descriptor “0” and hence blocks on SHELLRD FIFO instead of STDIN.

At block 910, the method makes SHELLWR FIFO in non-blocking mode, if the SHELLWR FIFO is not already created. At block 912, the method opens SHELLWR FIFO such that SHELLWR FIFO is assigned the lowest available file descriptor. At block 914, the method makes SHELLTEE FIFO, if the SHELLTEE FIFO is not already created.

At block 916, the method duplicates (or creates an alias) the standard output (STDOUT) file reference, using a dup command, such that a second file reference to STDOUT is generated. This duped STDOUT is used to write to the console, if the code wrapper for the server is launched from a console.

At block 918, the method closes standard output (STDOUT). Closing STDOUT relinquishes the file descriptor for the standard output. In certain instances, the file descriptor for STDIN is “1.”

At block 920, the method opens the SHELLTEE FIFO in Read/Write mode. Opening of the SHELLTEE FIFO assigns the SHELLTEE FIFO the lowest available file descriptor. Therefore, it is important to open the SHELLTEE FIFO as soon as the STDOUT is closed, so that the file descriptor for the STDOUT is assigned to the SHELLTEE FIFO. The SHELLTEE FIFO is used for the program 808 to write output to. The program 808 writes to the file associated with file descriptor “1” and hence blocks on SHELLTEE FIFO instead of STDOUT.

At block 922, the method creates a thread that monitors the SHELLTEE FIFO and directs the SHELLWR FIFO, console or both. The tee utility 806 thread is described in more detail in FIG. 10. The SHELLRD FIFO, SHELLWR FIFO and SHELLWD FIFO discussed in FIG. 9, FIG. 10 and FIG. 11 are examples of buffers that are used in creating named pipes as disclosed in FIG. 3, FIG. 4, FIG. 5, FIG. 6 and FIG. 7.

FIG. 10 is an example flow diagram 1000 illustrating a simplified method, according to certain aspects of the invention. In certain embodiments, the method disclosed in FIG. 10 is a tee utility disclosed as block 806 of FIG. 8. In certain embodiments, the method disclosed in FIG. 10 may be spawned off as a thread of instructions from block 922 of FIG. 9. The method disclosed in FIG. 9 may be performed using instructions stored in memory, such as a non-transient computer readable medium or system memory, using one or more processors. In certain embodiments, the method may be performed using one or more components disclosed with reference to FIG. 1 and FIG. 2. In certain embodiments, the method may be performed in a network device.

At block 1002, the method reads the data from the SHELLTEE FIFO. At block 1004, if data is available in the SHELLTEE FIFO, the method writes the data to the SHELLWR FIFO made and opened in FIG. 9.

At block 1006, if the code wrapper disclosed in FIG. 9 is launched from the console, then the method also writes to the console using the duped STDOUT file descriptor.

Blocks 1002, 1004 and 1006 may be repeated in a loop. In certain embodiments, the block 1002 may poll for additional data in the SHELLTEE FIFO. In yet other embodiments, an event may be generated once data (or data beyond a threshold) is stored in the SHELLTEE FIFO, such that instructions associated with blocks 1002, 1004 and 1006 are executed.

Momentarily, referring back to FIG. 8, the method of FIG. 10 allows the output written to file descriptor “1” that is stored in the SHELLTEE FIFO to be written to X 812 in FIG. 8 (SHELLWR FIFO) and the duplicate STDOUT that is Y 810 in FIG. 8 (console). In the above-described manner, the tee utility 806 allows the same input from the program 808 to be sent to the client (via X 812) and also displayed on the console (via Y 810). This is useful in instances where the server is started from the server, since it allows all the output to be sent to the console regardless of if the client is connected or not. This avoids scenarios where the data may be lost due to overflow of the FIFOs.

FIG. 11 is an example flow diagram 1100 illustrating a simplified method, according to certain aspects of the invention. In certain embodiments, the method disclosed in FIG. 11 is a client program or process as block 804 of FIG. 8. In certain embodiments, the method disclosed in FIG. 11 interacts with the program 808 using FIFOs that are described in FIG. 9 and FIG. 10. The method disclosed in FIG. 11 may be performed using instructions stored in memory, such as a non-transient computer readable medium or system memory, using one or more processors. In certain embodiments, the method may be performed using one or more components disclosed with reference to FIG. 1 and FIG. 2. In certain embodiments, the method may be performed in a network device.

In certain embodiments, at block 1102, if the SHELLRD FIFO is not already created, SHELLRD FIFO is made. In certain instances, the client may be initiated prior to the server. In such instances, at blocks 1102, the SHELLRD FIFO may already exist and making of SHELLRD FIFO in block 1102 is skipped.

At block 1104, SHELLRD FIFO is opened in non-blocking write mode. Non-blocking mode may be used to open the FIFO to avoid blocking the client from making progress until the server opens the SHELLRD FIFO as well. All or any of the FIFOs disclosed in FIG. 9 and FIG. 10 may be opened in non-blocking mode for the same reason.

In certain embodiments, at block 1106, if the SHELLWR FIFO is not already created, SHELLWR FIFO is made. In certain instances, the client may be initiated prior to the server. In such instances, at blocks 1106, the SHELLWR FIFO may already exist and making of SHELLRD FIFO in block 1106 may be skipped. At block 1108, SHELLWR FIFO is opened in non-blocking write mode.

The method disclosed in FIG. 11 may be invoked in an interactive mode or non-interactive mode. At block 1110, the method may determine if the client was invoked in interactive or non-interactive mode. In one embodiment, a flag may be set to indicate if the client was invoked in the interactive or non-interactive mode. In another embodiment, if the client was invoked with arguments to be provided to the server, then the client may be considered to have been invoked in non-interactive mode. On the other hand, if the client is invoked without any arguments, then the client may be considered to have been invoked in interactive mode. In the non-interactive mode, the client provides input to the program 808, receives output from the program 808 and terminates. In the interactive mode, the client continues to provide input and receive output from the program 808 until the client is manually terminated.

If the client is invoked in non-interactive mode, then blocks 1112, 1114, 1116 and 1118 are performed. At block 1112, the command from the client at the time of invoking the client may be retrieved. At block 1114, the command may be provided to the SHELLRD FIFO. The program 808 may process the command from the client and provide output to the client through the SHELLWR FIFO. At block 1116, the client reads the output from the SHELLWR FIFO. At block 1117, the client prints the output to its STDOUT.

If the client is invoked in interactive mode, then blocks 1120, 1122, 1124 and 1126 are performed in a loop. At block 1120, the commands are read in from the STDIN of the client. In certain embodiments, these commands may be provided by users or other programs. At block 1122, the command may be provided to the SHELLRD FIFO. The program 808 may process the command from the client and provide output to the client through the SHELLWR FIFO. At block 1124, the client reads the output from the SHELLWR FIFO. At block 1126, the client prints the output to its STDOUT. The program may loop back to block 1120. In certain embodiments, at block 1120, the method may poll for additional input from STDIN for the client. In yet other embodiments, an event may be generated once additional input is provided by the STDIN, such that instructions associated with blocks 1020, 1022, 1024 and 1026 are executed.

In certain embodiments, a non-transitory machine-readable or computer-readable medium is provided for storing data and code (instructions) that can be executed by one or more processors. Examples of non-transitory machine-readable or computer-readable medium include memory disk drives, Compact Disks (CDs), optical drives, removable media cartridges, memory devices, and the like. A non-transitory machine-readable or computer-readable medium may store the basic programming (e.g., instructions, code, program) and data constructs, which when executed by one or more processors, provide the functionality described above. In certain implementations, the non-transitory machine-readable or computer-readable medium may be included in a network device and the instructions or code stored by the medium may be executed by one or more processors of the network device causing the network device to perform certain functions described above. In some other implementations, the non-transitory machine-readable or computer-readable medium may be separate from a network device, but can be accessible to the network device such that the instructions or code stored by the medium can be executed by one or more processors of the network device causing the network device to perform certain functions described above. The non-transitory computer-readable or machine-readable medium may be embodied in non-volatile memory or volatile memory.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Features described with respect to certain embodiments may be combined in various other embodiments. Different aspects and elements of the embodiments may be combined in a similar manner. Technology evolves and, thus, many of the elements are examples that do not limit the scope of the disclosure to those specific examples.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

Although specific embodiments have been described, various modifications, alterations, alternative constructions, and equivalents are also encompassed within the scope of the described embodiments. Embodiments described herein are not restricted to operation within certain specific data processing environments, but are free to operate within a plurality of data processing environments. Additionally, although certain implementations have been described using a particular series of transactions and steps, it should be apparent to those skilled in the art that these are not meant to be limiting and are not limited to the described series of transactions and steps. Although some flowcharts describe operations as a sequential process, many of the operations can be performed in parallel or concurrently. In addition, the order of the operations may be rearranged. A process may have additional steps not included in the figure.

Further, while certain embodiments have been described using a particular combination of hardware and software, it should be recognized that other combinations of hardware and software may also be provided. Certain embodiments may be implemented only in hardware, or only in software (e.g., code programs, firmware, middleware, microcode, etc.), or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes can communicate using a variety of techniques including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method, comprising:
closing a standard input comprising a first file descriptor, wherein closing the standard input releases the first file descriptor;
assigning the first file descriptor to a first named pipe for receiving input from the first named pipe instead of the standard input;
closing a standard output comprising a second file descriptor, wherein closing the standard output releases the second file descriptor;
assigning the second file descriptor to a second named pipe for providing output previously directed to the standard output; and
starting a process, wherein input is received from the first named pipe and output is provided to the second named pipe.

2. The method of claim 1, further comprising sending data from the second named pipe to a third named pipe and a console at which the process was initiated.

3. The method of claim 1, wherein the process is a software development kit.

4. The method of claim 1, wherein the process is a foreground bound process.

5. The method of claim 1, wherein the method receives a first input from a client using the first named pipe that is then used by the process and the process provides a first output to the client using the second named pipe.

6. The method of claim 1, wherein assigning the first file descriptor to a first named pipe comprises opening the first named pipe immediately after closing the standard input, wherein opening of the first named pipe assigns the lowest available file descriptor to the first named pipe, and wherein the first file descriptor is “0.”

7. The method of claim 1, wherein assigning the second file descriptor to a second named pipe comprises opening the second named pipe immediately after closing the standard output, wherein opening of the second named pipe assigns the lowest available file descriptor to the second named pipe, and wherein the second file descriptor is “1.”

8. The method of claim 1, wherein the first named pipe is a first first in first out (FIFO) buffer and the second named pipe is a second FIFO buffer.

9. The method of claim 1, wherein the method is performed by a server process executing on a network device.

10. A non-transitory computer-readable storage medium, wherein the non-transitory computer-readable storage medium comprises instructions executable by a processor, the instructions comprising instructions to:
close a standard input comprising a first file descriptor, wherein closing the standard input releases the first file descriptor;
assign the first file descriptor to a first named pipe for receiving input from the first named pipe instead of the standard input;
close a standard output comprising a second file descriptor, wherein closing the standard output releases the second file descriptor;
assign the second file descriptor to a second named pipe for providing output previously directed to the standard output; and
start a process, wherein input is received from the first named pipe and output is provided to the second named pipe.

11. The non-transitory computer-readable medium of claim 10, further comprising instructions to send data from the second named pipe to a third named pipe and a console at which the process was initiated.

12. The non-transitory computer-readable medium of claim 10, wherein the process is a software development kit.

13. The non-transitory computer-readable medium of claim 10, wherein the process is a foreground bound process.

14. The non-transitory computer-readable medium of claim 10, wherein assigning the first file descriptor to a first named pipe comprises opening the first named pipe immediately after closing the standard input, wherein opening of the first named pipe assigns the lowest available file descriptor to the first named pipe, and wherein the first file descriptor is “0.”

15. The non-transitory computer-readable medium of claim 10, wherein assigning the second file descriptor to a second named pipe comprises opening the second named pipe immediately after closing the standard output, wherein opening of the second named pipe assigns the lowest available file descriptor to the second named pipe, and wherein the second file descriptor is “1.”

16. The non-transitory computer-readable medium of claim 10, wherein the first named pipe is a first first in first out (FIFO) buffer and the second named pipe is a second FIFO buffer.

17. A method for interacting with a server process, comprising:
creating a first named pipe and a second named pipe;
providing a first input to the server process using the first named pipe;
receiving a second output from the server process using the second named pipe; and
printing data associated with the second output at a console associated with the method executed by a client process.

18. The method of claim 17, wherein the server process is a foreground bound process and the client process is a foreground bound process.

19. The method of claim 17, wherein the client process is initiated in non-interactive mode, wherein the client process terminates after printing the data from the second output.

20. The method of claim 17, wherein the client process is initiated in interactive mode, wherein the client process continues providing additional input using the first named pipe to the server process and receiving additional output using the second named pipe from the server process using the second named pipe.
